(19) United States
(12) Patent Application Publication
(10) Pub. No.: US 2015/0149255 A1
(43) Pub. Date: May 28, 2015

(54) ROBUST PRICING SOLUTION FOR PRODUCTS AND SERVICES

(71) Applicant: International Business Machines Corporation, Armonk, NY (US)

(72) Inventors: Olivier Gallay, Zurich (CH); Ban Kawas, Irvington, NY (US)

(73) Assignee: International Business Machines Corporation, Armonk, NY (US)

(21) Appl. No.: 14/091,737

(22) Filed: Nov. 27, 2013

(51) Int. Cl. G06Q 30/02; G06Q 50/14

(52) U.S. Cl. CPC G06Q 30/0206; G06Q 50/14
USPC 705/7.35

(57) ABSTRACT

In one embodiment, a computer-implemented method includes identifying a plurality of origin-destination (OD) pairs within a transportation network. A plurality of ranges for price elasticities may be calculated, where the ranges include at least one price elasticity range for each of the OD pairs, and where, for each OD pair, the associated range of the price elasticity spans multiple values. A robustness parameter may be received. A pricing scheme may be calculated, by a computer processor, based at least in part on the robustness parameter, where the pricing scheme includes a price for each of the OD pairs in the network and is at least partially based on the robustness parameter and the plurality of ranges for the price elasticities.

### BACKGROUND

Various embodiments of this disclosure relate to pricing systems and, more particularly, to robust pricing solutions for transportation networks as well as other products and services.

Pricing and resulting revenue management is of central and increasing importance in the travel and transportation (T&T) industry, as well as other product and service industries. Thanks to the ever-growing liberalization in T&T, pricing is one of the most strategic and powerful ways T&T companies can improve their business and financial performances. From a marketing perspective, pricing impacts passenger satisfaction and trust in transportation companies. In addition, pricing is a powerful tool in capacity management and load balancing. The recent economic downturn has forced transportation companies to reevaluate their pricing practices to reclaim margins without putting too much revenue at risk. For all these reasons, the global T&T industry is moving from single-mode, static pricing models to a new demand for integrated fare management with multi-modal, relational, and automated pricing intelligence to optimize its pricing schemes.

In the current industrial practice, there are several ways in which a pricing scheme may be designed. A basic approach, adapted mostly in the railway and coach segments, is distance-based pricing, where the fare between an origin-destination (OD) pair is based on the distance covered. A more advanced pricing scheme is direct-connection pricing, where the fare for every individual OD pair is set independently to maximize revenue on the particular connection, taking into account political and business constraints. To estimate revenue, a good approximation is needed about passengers' potential reactions to fare changes. When quantified, this reaction to price changes is referred to as the price elasticity, or the price elasticity of demand. Price elasticity indicates how future demand will depend on an adopted price.

Price elasticity is difficult to estimate. While reliable historical data is generally available, such data contains too little statistical information to provide good estimations at the OD scale. The limited availability of data needed to accurately estimate the price elasticity per OD pair, as well as the existence of other potential sources of randomness (e.g., competitor actions, the global state of the economy, and the current demographic situation), creates uncertainty in price elasticity. If actual price elasticity takes a different value than an estimated one used during a price optimization attempt, that attempted price optimization may then be less than optimal, and the expected revenue would not be reached. Thus, a decision-maker who uses the estimated price elasticity in his pricing adopts a solution with greater risk than he might expect.

Currently, the randomness in price elasticity is often omitted from consideration in practice. This leads to pricing schemes that are directly exposed to uncertainty. Some simplistic solutions have been used, all vulnerable to uncertainty. The Average-Based Optimization solution considers only a nominal value of price elasticity, omitting fluctuations that might occur in the future. As a consequence, a computed pricing scheme is highly exposed to risk, and expected global revenue likely will not be reached. The Worst-Case Analysis solution considers only the worst possible case for the price elasticity. This leads to a solution that is too conservative, and although the expected revenue will be achieved, the resulting pricing scheme is not optimal for the applicable company as potential revenue will be missed.

### SUMMARY

In one embodiment of this disclosure, a computer-implemented method includes identifying a plurality of origin-destination (OD) pairs within a transportation network. A plurality of ranges for price elasticities may be calculated, where the ranges include at least one price elasticity range for each of the OD pairs, and where, for each OD pair, the associated range of the price elasticity spans multiple values. A robustness parameter may be received. A pricing scheme may be calculated, by a computer processor, based at least in part on the robustness parameter, where the pricing scheme includes a price for each of the OD pairs in the network and is at least partially based on the robustness parameter and the plurality of ranges for the price elasticities.

In another embodiment, a system includes a model construction unit, a model parameter unit, and an execution unit. The model construction unit is configured to identify a plurality of OD pairs within a transportation network; and calculate a plurality of ranges for price elasticities, comprising at least one price elasticity range for each of the OD pairs, wherein for each OD pair the associated range of the price elasticity spans multiple values. The model parameter unit is configured to receive a robustness parameter. The execution unit is configured to calculate a pricing scheme based at least in part on the robustness parameter, where the pricing scheme includes a price for each of the OD pairs in the network and is at least partially based on the robustness parameter and the plurality of ranges for the price elasticities.

In yet another embodiment, a computer program product includes a computer readable storage medium having computer readable program code embodied thereon. The computer readable program code is executable by a processor to perform a method. The method includes identifying a plurality of OD pairs within a transportation network. Further according to the method, a plurality of ranges for price elasticities may be calculated, where the ranges include at least one price elasticity range for each of the OD pairs, and where, for each OD pair, the associated range of the price elasticity spans multiple values. A robustness parameter may be received. A pricing scheme may be calculated based at least in part on the robustness parameter, where the pricing scheme includes a price for each of the OD pairs in the network and is at least partially based on the robustness parameter and the plurality of ranges for the price elasticities.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computing device for implementing one or more aspects of a pricing system, according to some embodiments of this disclosure;

FIG. 2 is a block diagram of the pricing system, according to some embodiments of this disclosure; and

FIG. 3 is a graphical illustration of four potential uncertainty sets considered by the pricing system for different levels of robustness, according to some embodiments of this disclosure.

### DETAILED DESCRIPTION

Various embodiments of this disclosure a pricing systems and methods that provide robust pricing schemes based on estimated ranges for price elasticity of demand.

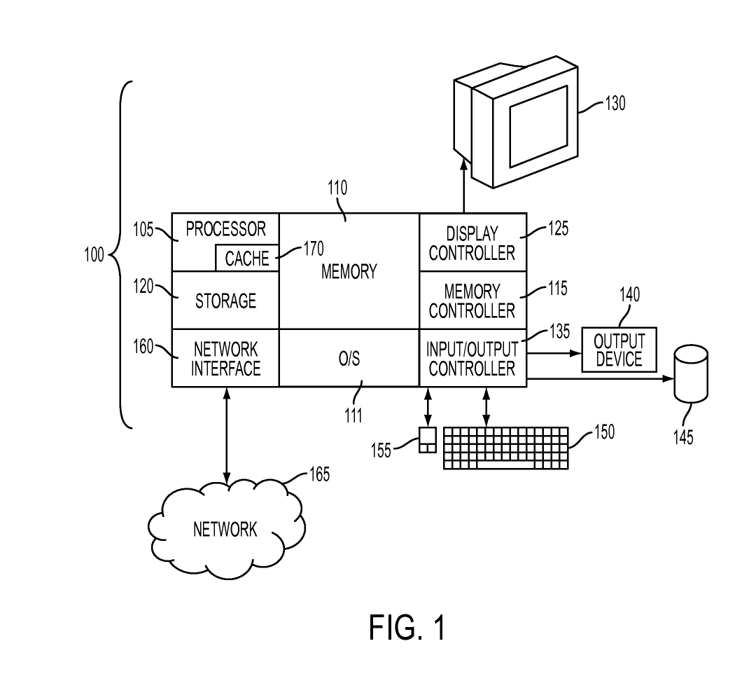

FIG. 1 illustrates a block diagram of a computer system 100 for use in implementing a pricing system or method according to some embodiments. The pricing systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 100, such as a personal computer, workstation, minicomputer, or mainframe computer.

In an exemplary embodiment, as shown in FIG. 1, the computer system 100 includes a processor 105, memory 110 coupled to a memory controller 115, and one or more input devices 145 and/or output devices 140, such as peripherals, that are communicatively coupled via a local I/O controller 135. These devices 140 and 145 may include, for example, a printer, a scanner, a microphone, and the like. A conventional keyboard 150 and mouse 155 may be coupled to the I/O controller 135. The I/O controller 135 may be, for example, one or more buses or other wired or wireless connections, as are known in the art. The I/O controller 135 may have additional elements, which are omitted for simplicity, such as controllers, buffers (caches), drivers, repeaters, and receivers, to enable communications.

The I/O devices 140, 145 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 105 is a hardware device for executing hardware instructions or software, particularly those stored in memory 110. The processor 105 may be any custom made or commercially available processor, a central processing unit (CPU), an auxiliary processor among several processors associated with the computer system 100, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive or solid state drive. The stored instructions in memory 110 or in storage 120 may include those enabling the processor to execute one or more aspects of the pricing systems and methods of this disclosure.

The computer system 100 may further include a display controller 125 coupled to a display 130. In an exemplary embodiment, the computer system 100 may further include a network interface 160 for coupling to a network 165. The network 165 may be an IP-based network for communication between the computer system 100 and any external server, client and the like via a broadband connection. The network 165 transmits and receives data between the computer system 100 and external systems. In an exemplary embodiment, the network 165 may be a managed IP network administered by a service provider. The network 165 may be implemented in a wireless fashion, e.g., using wireless protocols and technologies, such as WiFi, WiMax, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Pricing systems and methods according to this disclosure may be embodied, in whole or in part, in computer program products or in computer systems 100, such as that illustrated in FIG. 1.

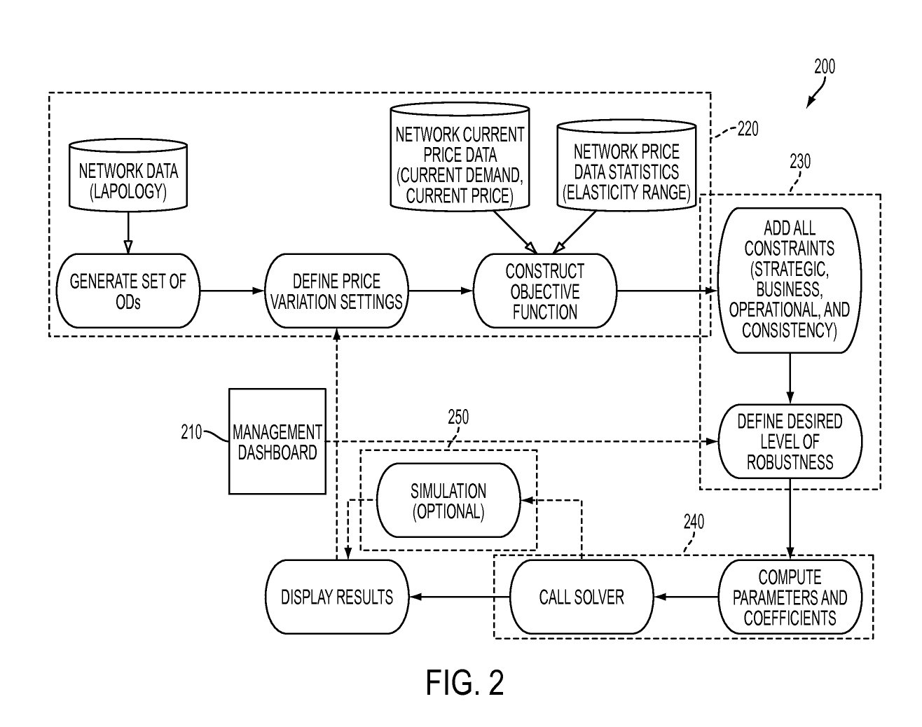

FIG. 2 is a block diagram of a pricing system 200, according to some embodiments of this disclosure. According to some embodiments, the pricing system 200 may provide a range of values for the price elasticity of demand, thereby enabling decision-makers to set pricing schemes based on their desired levels of risk.

Conventional solutions for pricing schemed rely on only a nominal value, or lowest reasonable value, of the price elasticity. As a result, these conventional solutions either present too much risk, or cause the decision-maker to fail to capture an adequate amount of the potential future revenue.

An embodiment of the pricing system uses a range of values for the price elasticity. This range may account for possible fluctuations that could affect the real value of price elasticity that will be observed in the future. From a practical point of view, statistics obtained from available historical data may allow for a good computation of such a range, even in cases where a good quality estimation of the nominal value would have been impossible.

Generally, the pricing system 200 may provide a pricing optimization tool that is automated, integrated, and either online or offline. The pricing system 200 may efficiently calculate a robust pricing scheme, taking into account the uncertainty affecting estimation of price elasticity. Refined mathematical methods may enable the pricing system 200 to provide an optimal or near-optimal solution, up to the desired level of robustness. The pricing system 200 may automatically avoid price schemes that involve too high an exposure to risk. Additionally, the pricing system 200 may enable the decision-maker to add one or more constraints to the pricing optimization problem. These constraints may include, for example, business, operational, strategic, or consistency constraints.

According to some embodiments of the pricing system 200, a price or pricing scheme for a transportation network may be represented as an objective function describing the revenue made over all ODs in the network, and hence taking as input the possible values of the price elasticities. Thus, by using a range of values for the price elasticities and optimizing the objective function, the pricing system 200 may handle the underlying uncertainty that arises.

The pricing system 200 may use a robustness parameter, which may be represented in various ways. For example, and not by way of limitation, the robustness parameter may be represented as an integer in the range of 0 to the number of routes, or the number of OD pairs, to be priced in the network, where higher values indicate a greater desired level of robustness. By modifying this robustness parameter, the decision-maker may tune the resulting pricing schemes output by the pricing system 200. With a low robustness parameter, the pricing system 200 may output a conservative solution, providing low exposure to risk but possibly being sub-optimal. With a high robustness parameter, the pricing system 200 may output a pricing scheme resulting in a higher expect revenue but also having a high exposure to risk. Some embodiments of the pricing system 200 use a budgeted polyhedral uncertainty set, in which a single intuitive parameter, referred to as the “budget of uncertainty,” limits the number of uncertain variables that reach their worst-case scenario at optimality, thus reflecting various levels of risk-averseness or conservatism that the decision-maker is willing to adopt. Contrary to conventional approaches, the pricing system 200 may enable the decision-maker to tune what part of the expected revenue he wants to expose to risk, thereby allowing him to have guarantees to business partners as needed.

Returning now to FIG. 2, an embodiment of the pricing system 200 is shown, including a flow diagram of various activates occurring within the pricing system 200. As shown, the pricing system 200 may include a management dashboard 210, through which the decision-maker my operate the pricing system 200. The pricing system 200 may further include units, which may include hardware, software, or a combination of both, for model construction 220, model parameters 230, execution 240, and simulation 250. Each of these units may be accessible through the dashboard 210, which may provide an interface for the decision-maker.

The model construction unit 220 may enable the decision-maker to view or construct a model of a transportation network, or other network of goods or services. To this end, the model construction unit may have, or may access, one or more databases containing network data describing the topology of the network. It will be understood that, as used herein, the term “database” is not limited to a relational database, but may instead refer to various means for maintaining and organizing data. In the case of a transportation network, the network data may describe transportation routes, which may include information about OD pairs. From the network data, the model construction unit 220 may construct the OD pairs in need of pricing. The model construction unit 220 may then optimize the objective pricing function, thereby outputting a pricing scheme for the various OD pairs. It will be understood that one or more routes may exist between each OD pair. Some embodiments of the pricing system may be configured to price each route separately, while some embodiments may be configured to output the same price for the various routes between an OD pair, thereby treating each OD pair as a route for the purpose of pricing. Accordingly, in general, the computed pricing scheme may include at least one price per OD pair, which may include a price for each route between each OD pair.

It will be further understood that the term “optimize” as used herein need not refer to the best possible solution, as the “best possible” is a subjective concept. Rather, when the pricing system 200 performs optimization, it may compute a solution that meets given criteria. The optimization performed may be based, at least in part, on current pricing and current demand of the OD pairs, and may be further based on statistics related to an elasticity range to incorporate the desired level of robustness.

The model parameter unit 230 may enable the decision-maker to input one or more parameters for the objective function. These parameters may influence the output of the pricing system 200. Such parameters may include, for example, price variation settings (e.g., setting minimum and maximum prices), level of robustness, and constraints related to business, strategy, consistency, or operational issues. The model parameter unit 230 may also display various scenarios based on the current parameters being used. Through the model parameter unit 230, the decision-maker may be enabled to manage, display, and compare various scenarios based on various sets of model parameters. For example, the model parameter unit 230 may present a comparison between pricing schemes for various levels of robustness.

The execution unit 240 may implement the calculations discussed below, based on parameters selected by the decision-maker, and may thereby output a pricing scheme that is deemed optimal based on those parameters.

The simulation unit 250 may provide revenue simulations based on one or more values for the price elasticities in a determined possible range of the actual price elasticity, and further based on one or more pricing schemes. The simulation unit 240 may calculate the probabilities of each potential revenue result given the possible price elasticities and pricing schemes.

A transportation network may be the object of revenue optimization performed by the pricing system 200, according to some embodiments of this disclosure. The framework used throughout the remainder of this disclosure, referring to an exemplary transportation network, is as follows:

Within the transportation network, there exists a set of stations N={1, . . . , N}. The pricing performed by an embodiment of the pricing system 200 may include setting the price of standard tickets offered to customers for some or all OD pairs, or OD links Lᵢⱼ, where i, jεN and i≠j in the network, where each OD link represents at least one route between the origin and destination of the respective OD. The price of a ticket for the route spanning Lᵢⱼ is denoted Pᵢⱼ. When considering direction-dependent prices (i.e., where Pᵢⱼ and Pᵢⱼ might differ), the number M of different ODs to be considered in the network is given by M=N*(N−1). In the case of direction-independent pricing, the number of ODs is then M=0.5*N*(N−1). The pricing system 200 may enable the decision-maker to select whether pricing should be made direction-dependent or direction-independent. The specific demand for a particular OD Lᵢⱼ is denoted by Dᵢⱼ.

The pricing system 200 may operate where the current price P₁ and the current demand Dᵢⱼ are known for each OD link Lᵢⱼ. The pricing system 200 may identify a new pricing scheme, which may include a new set of prices, Pᵢⱼ for some or all OD pairs, so as to potentially maximize the global revenue for the entire transportation network, based on the degree of conservativeness indicated by the robustness parameter.

It is generally agreed that price changes inversely affect demand. More specifically, price increases result in decreased demand, and price decreases result in increased demand. More specifically, given the current model framework, when prices are increased for a particular OD link Lᵢⱼ, the corresponding demand is expected to take a corresponding value Dᵢⱼ that is less than or equal to the current demand. Price elasticity of demand is a measure of consumer responsiveness to price changes in terms of demand. In some embodiments, this measure represents the percentage change in demand in response to a one percent change in price. Many factors can, directly or indirectly, influence the price elasticity of an OD link Lᵢⱼ. These factors include, for example, ratio of commuters to non-commuters, quality of service, and trip length. In some cases, these factors may be particular to each OD pair, such that a first OD pair may experience a different effect from a price change as compared to a second OD pair. Based on differential calculus, price elasticities eᵢⱼ at a given point on a demand curve may be estimated using the following equation, where the “cur” superscript indicates a current value and the “new” superscript indicates a new value to be calculated:

$${e}_{ij} = \frac{{P}_{ij}^{cur}}{{D}_{ij}^{cur}} * \frac{{D}_{ij}^{new} - {D}_{ij}^{cur}}{{P}_{ij}^{new} - {P}_{ij}^{cur}} \qquad ( 1 )$$

Given the inverse relationship between each Pᵢⱼ and its corresponding Dᵢⱼ, it may be the case that eᵢⱼ<0 for all i, jεN, where i≠j. When |eᵢⱼ|≦1 for a given OD link Lᵢⱼ, then that OD pair may be deemed to be inelastic (i.e., price changes of tickets associated with Lᵢⱼ do not have large effects on the number of tickets sold). Conversely, when |eᵢⱼ|>1, the associated OD pair may be deemed elastic. It will be understood that other definitions of “elastic” and “inelastic” may also be used.

Rearranging the terms in Equation 1, the following may be obtained and used to calculate the new demand as a function of a new price:

$${D}_{ij}^{new} = ( 1 - {e}_{ij} ) {D}_{ij}^{cur} + {e}_{ij} \frac{{D}_{ij}^{cur}}{{P}_{ij}^{cur}} {P}_{ij}^{new} \qquad ( 2 )$$

The current global revenue R^{cur} for the network may be calculated as the sum of revenues generated over all OD pairs using current prices and demands. Where the revenue generated by a particular OD link Lᵢⱼ is given by R(Pᵢⱼ, Dᵢⱼ), the current revenue may be as follows for all i≠j:

$${R}^{cur} = {\sum }_{i , j ∈ N} R ( {P}_{ij}^{cur} , {D}_{ij}^{cur} ) \qquad ( 3 )$$

The global revenue R^{new} after a price modification may be:

$${R}^{new} = {\sum }_{i , j ∈ N} R ( {P}_{ij}^{new} , {D}_{ij}^{new} ) \qquad ( 4 )$$

Generally, the decision-maker will want to identify price schemes that optimize his preferences in terms of risk-return tradeoffs, and thereby optimize the new global revenue. To this end, the decision-maker seeks to determine how much he can increase current prices in a way that does not drastically drive away demand. In practice, ticket prices rarely decrease, even without taking into consideration long-term inflation. Decision-makers almost always either increase the prices of standard tickets or leave them unchanged. Even if it would actually bring more revenue from the increased demand, a price decrease might have negative effects on customer satisfaction and the associated corporate image. Price decreases can give customers the impression that fares were previously overpriced and that customers have been ripped-off in the past. Thus, avoidance of price decreases is the general practice. Prices within the context of promotional sales are usually temporary and do not represent prices of standard tickets that are available year round. Embodiments of the pricing system 200 may be generally directed toward standard ticket prices, but it will be understood that promotional pricing may also be calculated with varying sets of input parameters and other considerations.

The pricing system 200 may identify new prices for each of the OD links Lᵢⱼ, where i≠j, so as to potentially maximize the new revenue R^{new} given by Equation 4. Using the expression for the new Dᵢⱼ in Equation 2, the following convex optimization model may be obtained, given each i≠j:

$${P}_{ij}^{new} = {\sum }_{i , j ∈ N} ( 1 - {e}_{ij} ) {D}_{ij}^{cur} {P}_{ij}^{new} + {e}_{ij} \frac{{D}_{ij}^{cur}}{{P}_{ij}^{cur}} {( {P}_{ij}^{new} )}^{2} \qquad ( 5 )$$

The above equation is unconstrained with a quadratic objective and can be efficiently solved via various existing solvers. However, the main challenge facing practitioners when attempting to use such a model lies in the estimation of its parameters, particularly estimating the values of price elasticities eᵢⱼ for the various OD links Lᵢⱼ. This is due to the limited availability of data needed to accurately estimate these elasticities. If price elasticities take different values than estimated nominal elasticity values used in solving the model given by Equation 5, obtained solutions may become sup-optimal, and can cause the decision-maker adopting these solutions to take on more risk than he is willing to accept.

As mentioned above, it is difficult to obtain precise and accurate estimates of elasticities. According to various embodiments of this disclosure, however, it may be assumed that each price elasticity, for all OD links Lᵢⱼ where i≠j, falls into the following range:

eᵢⱼε[ēᵢⱼ−êᵢⱼ,ēᵢⱼ+êᵢⱼ] (6)

In the above ēᵢⱼ≦0 is the nominal point estimate of the price elasticity eᵢⱼ of OD link Lᵢⱼ, and êᵢⱼ>0 is the estimation error, i.e., the possible fluctuation around that nominal value. Embodiments of the pricing system 200 may operate under the assumption that the range in Equation 6 is attainable for each OD pair.

The pricing system 200 may model price elasticities as uncertain parameters belonging to bounded symmetrical confidence intervals, such as the interval shown in Equation 6. Where zᵢⱼ is a random variable in [−1,1] that obeys an unknown symmetric distribution, the various price elasticities may be represented as follows:

eᵢⱼ+ēᵢⱼ+êᵢⱼzᵢⱼ (7)

The pricing system 200 may address risks stemming from data uncertainty in the optimization model of Equation 5 by adopting a robust optimization approach. This approach may be a worst-case approach in which the worst-case global revenue is sought to be maximized over a set of reasonable variations in price elasticities reflecting the corresponding demand variations triggered by potential price changes. Since it is assumed that price elasticities are OD-specific and are independent of one another, it may be unrealistic in practice that every price elasticity will be at its worst-case value. Indeed, from the law of large numbers, some will likely be higher than their nominal estimations, and some will likely be lower. The pricing system 200 may use a model that limits the number of price elasticity values that can vary from their nominal estimations by a fixed budget. This budget may be determined, at least in part, by the robustness parameter. In some embodiments, depending on the format used for the robustness parameter, the budget may take the same value as this parameter. The budget Γ may be defined as follows, for i≠j:

$$Γ \geq {\sum }_{i , j ∈ N} \vert {z}_{ij} \vert \qquad ( 8 )$$

When Γ=0, then none of the uncertain elasticities may be allowed to deviate from their nominal values ēᵢⱼ, and thus the model may be rendered to the original one given in Equation 5. In contrast, when Γ is equal to the number of ODs in the network, then all price elasticity parameters may be allowed to vary and potentially reach their worst-case values within their respective admissible ranges.

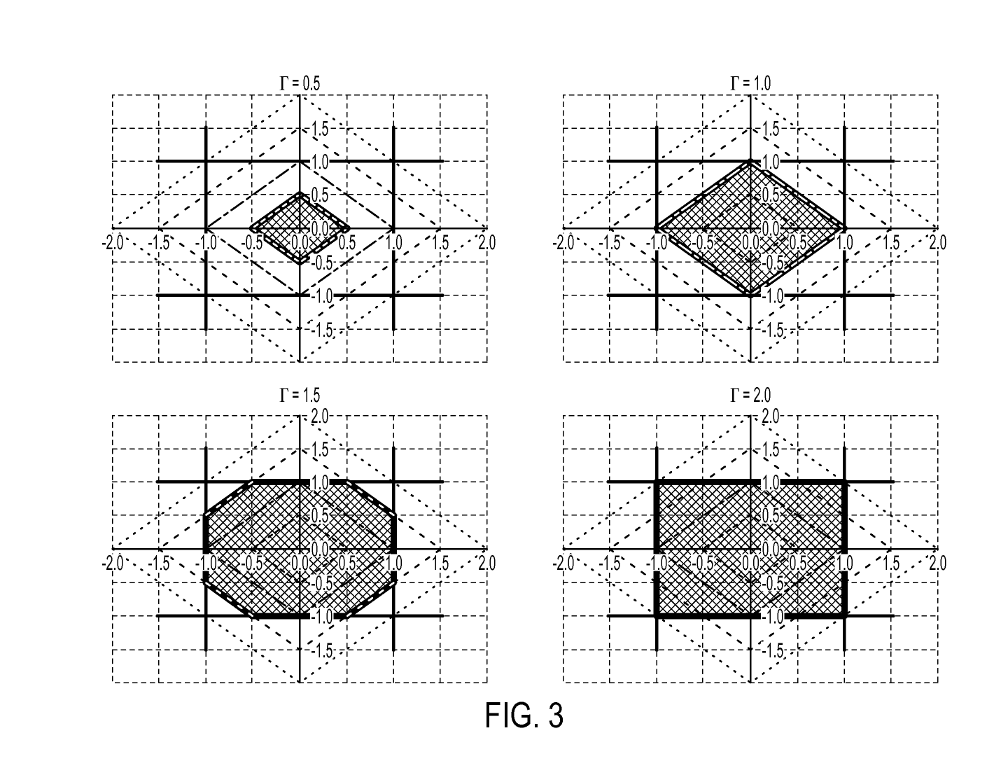

FIG. 3 is a graphical illustration of four typical uncertainty sets considered for different levels of robustness and corresponding budgets Γ, in the case of a two-dimensional problem. FIG. 3 illustrates how the budget Γ may directly control the size of the uncertainty set in conjunction with bounds imposed on the uncertain parameters.

Configuring the optimization model given in Equation 5, and incorporating the uncertainty model discussed above, the following max-min formulation can be obtained:

$${max}_{{P}_{ij}^{new}} {min}_{{\overline{z}}_{ij}} {\sum }_{i , j ∈ N , i \neq j} ( 1 - ( {\overline{e}}_{ij} + {\hat{e}}_{ij} {\overline{z}}_{ij} ) ) {D}_{ij}^{cur} {P}_{ij}^{new} + ( {\overline{e}}_{ij} + {\hat{e}}_{ij} {\overline{z}}_{ij} ) \frac{{D}_{ij}^{cur}}{{P}_{ij}^{cur}} {( {P}_{ij}^{new} )}^{2} \\ s . t . {\sum }_{i , j ∈ N , i \neq j} \vert {\overline{z}}_{ij} \vert \leq Γ \\ \vert {\overline{z}}_{ij} \vert \leq 1 ∀ i , j ∈ N , i \neq j \qquad ( 9 )$$

The inner minimization problem above may be convexified and rewritten as a maximization, obtaining the following tractable robust optimization model, which may be used by the pricing system 200.

$${max}_{{P}_{ij}^{new}} {\sum }_{i , j ∈ 𝒩 , i \neq j} ( 1 - {\overline{e}}_{ij} + {\overline{e}}_{ij} \frac{{P}_{ij}^{new}}{{P}_{ij}^{cur}} ) {D}_{ij}^{cur} {P}_{ij}^{new} - αΓ - {\sum }_{i , j ∈ 𝒩 , i \neq j} {ξ}_{ij} \\ s . t . α + {ξ}_{ij} - {\hat{e}}_{ij} {P}_{ij}^{new} {D}_{ij}^{cur} ( \frac{{P}_{ij}^{new}}{{P}_{ij}^{cur}} - 1 ) \geq 0 ∀ i , j ∈ 𝒩 , i \neq j \\ {ξ}_{ij} \geq 0 ∀ i , j ∈ 𝒩 , i \neq j . α \geq 0 \qquad ( 10 )$$

The decision-maker can make various choices incorporated by the pricing system 200 in developing a pricing scheme. For instance, the decision-maker may choose the value of the potential error in price elasticities, which error is represented by êᵢⱼ herein. The decision-maker can also manage the size of uncertainty sets used by varying a single intuitive control parameter, the robustness parameter, and hence defining the budget Γ that may act on the robustness level of the computed pricing scheme. When the decision-maker is more conservative, then a larger level of robustness, and thus a larger budget Γ, may be more appropriate. If the decision-maker is willing to be less conservative and take on more risk, then he may prefer a smaller budget Γ.

As described herein, the pricing system 200 may be an automated decision support tool, configured to provide robust pricing scheme solutions. Although the focus of this disclosure is on transportation networks, it will be understood that various embodiments of the pricing system 200 may be applicable to other fields where price elasticity is uncertain. Further, some embodiments may be applicable outside of pricing and demand, where a first factor is based on a second factor in an uncertain manner. For example, and not by way of limitation, embodiments of the pricing system 200 may be applicable to consumer goods and services; multiple-channel marketing, based on advertising elasticity; inventory control and stock management, in which replenishment parameters influence the service level; communication networks, based on bandwidth or latency-backlog reaction; biochemistry, based on a biological systems response factor; and structural engineering, based on Hooke's law of elasticity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying a plurality of origin-destination (OD) pairs within a transportation network;
calculating a plurality of ranges for price elasticities, comprising at least one price elasticity range for each of the OD pairs, wherein for each OD pair the associated range of the price elasticity spans multiple values;
receiving a robustness parameter;
calculating, by a computer processor, a pricing scheme based at least in part on the robustness parameter, wherein the pricing scheme includes a price for each of the OD pairs in the network and is at least partially based on the robustness parameter and the plurality of ranges for the price elasticities.

2. The method of claim 1, wherein a first range for a first price elasticity corresponding to a first OD pair in the network comprises a nominal price elasticity and a degree of error for the nominal price elasticity.

3. The method of claim 1, further comprising:
determining a budget of uncertainty based on the robustness parameter;
wherein calculating the pricing scheme is based on a set of applied elasticities, wherein the applied elasticity for each OD pair is within the corresponding range for the price elasticity of the OD pair, and wherein a quantity of the applied elasticities that differ from the nominal values in their corresponding ranges is at least partially based on the budget.

4. The method of claim 3, wherein a first value of the budget sets each of the values of the applied elasticities to the corresponding nominal price elasticity.

5. The method of claim 4, wherein a second value of the budget enables each of the values of the applied elasticities to differ from the corresponding nominal price elasticity, and wherein the first value and the second value of the budget are distinct.

6. The method of claim 1, wherein the robustness parameter determines a general level of risk affecting the pricing scheme for the OD pairs in the network.

7. The method of claim 1, further comprising:
receiving one or more pricing constraints;
wherein calculating the pricing scheme comprises maximizing an expected future revenue for the network based at least in part on the robustness parameter, the one or more pricing constraints, and the plurality of ranges of the price elasticities of the OD pairs in the network.

8. A system comprising:
a model construction unit configured to:
identify a plurality of origin-destination (OD) pairs within a transportation network; and
calculate a plurality of ranges for price elasticities, comprising at least one price elasticity range for each of the OD pairs, wherein for each OD pair the associated range of the price elasticity spans multiple values;
a model parameter unit configured to receive a robustness parameter; and
an execution unit configured to calculate a pricing scheme based at least in part on the robustness parameter, wherein the pricing scheme includes a price for each of the OD pairs in the network and is at least partially based on the robustness parameter and the plurality of ranges for the price elasticities.

9. The system of claim 8, wherein a first range for a first price elasticity corresponding to a first OD pair in the network comprises a nominal price elasticity and a degree of error for the nominal price elasticity.

10. The system of claim 8, wherein the execution unit is further configured to:
determine a budget based on the robustness parameter, wherein calculating the pricing scheme is based on a set of applied elasticities;
wherein the applied elasticity for each OD pair is within the corresponding range for the price elasticity of the OD pair, and wherein a quantity of the applied elasticities that differ from the nominal values in their corresponding ranges is at least partially based on the budget.

11. The system of claim 10, wherein a first value of the budget sets each of the values of the applied elasticities to the corresponding nominal price elasticity.

12. The system of claim 11, wherein a second value of the budget enables each of the values of the applied elasticities to differ from the corresponding nominal price elasticity, and wherein the first value and the second value of the budget are distinct.

13. The system of claim 8, wherein the robustness parameter determines a level of risk affecting the pricing scheme for the OD pairs in the network.

14. The system of claim 8, wherein the model parameter unit is further configured to receive one or more pricing constraints, and wherein the execution unit is configured to calculate the pricing scheme by maximizing an expected future revenue of the network based at least in part on the robustness parameter, the one or more pricing constraints, and the plurality of ranges of the price elasticities of the OD pairs in the network.

15. A computer program product comprising a computer readable storage medium having computer readable program code embodied thereon, the computer readable program code executable by a processor to perform a method comprising:
identifying a plurality of origin-destination (OD) pairs within a transportation network;
calculating a plurality of ranges for price elasticities, comprising at least one price elasticity range for each of the OD pairs, wherein for each OD pair the associated range of the price elasticity spans multiple values;
receiving a robustness parameter;
calculating a pricing scheme based at least in part on the robustness parameter, wherein the pricing scheme includes a price for each of the OD pairs in the network and is at least partially based on the robustness parameter and the plurality of ranges for the price elasticities.

16. The computer program product of claim 15, wherein a first range for a first price elasticity corresponding to a first OD pair in the network comprises a nominal price elasticity and a degree of error for the nominal price elasticity.

17. The computer program product of claim 15, the method further comprising:
determining a budget based on the robustness parameter;
wherein calculating the pricing scheme is based on a set of applied elasticities, wherein the applied elasticity for each OD pair is within the corresponding range for the price elasticity of the OD pair, and wherein a quantity of the applied elasticities that differ from the nominal values in their corresponding ranges is at least partially based on the budget.

18. The computer program product of claim 17, wherein a first value of the budget sets each of the values of the applied elasticities to the corresponding nominal price elasticity.

19. The computer program product of claim 18, wherein a second value of the budget enables each of the values of the applied elasticities to differ from the corresponding nominal price elasticity, and wherein the first value and the second value of the budget are distinct.

20. The computer program product of claim 15, the method further comprising:
receiving one or more pricing constraints;
wherein calculating the pricing scheme comprises maximizing an expected future revenue of the network based at least in part on the robustness parameter, the one or more pricing constraints, and the plurality of ranges of the price elasticities of the OD pairs in the network; and
wherein the robustness parameter determines a level of risk affecting the pricing scheme.
